(19) United States
(12) Patent Application Publication
(10) Pub. No.: US 2008/0217859 A1
(43) Pub. Date: Sep. 11, 2008

(54) Speed fit brush seal

(75) Inventor: Mark E. Addis, Kennebunk, ME (US)

Correspondence Address: KINNEY & LANGE, P.A., THE KINNEY & LANGE BUILDING, 312 SOUTH THIRD STREET, MINNEAPOLIS, MN, 55415-1002, US

(73) Assignee: United Technologies Corporation, Hartford, CT (US)

(21) Appl. No.: 11/714,536

(22) Filed: Mar. 5, 2007

(51) Int. Cl. F16J 15/16; F16J 15/44; F16J 15/447

(52) U.S. Cl. 277/303; 277/347; 277/355

(57) ABSTRACT

A seal assembly includes a component of a gas turbine engine having a circumferential surface, a first knife edge seal, a second knife edge seal, and a brush seal assembly. The first knife edge seal and the second knife edge seal extend radially from the circumferential surface of the component and form a gap at the circumferential surface of the component between the first knife edge seal and the second knife edge seal. The brush seal assembly is positioned within the gap between the first knife edge seal and the second knife edge seal and is attached to the circumferential surface of the component.

### BACKGROUND OF THE INVENTION

The present invention generally relates to seals. In particular, the present invention relates to a seal assembly including a labyrinth seal assembly and a brush seal assembly.

Seals such as labyrinth seals and brush seals are commonly used in gas turbine engines and other assemblies to restrict the escape of a working medium (e.g. air) from the main flowpath through a gap between a stationary part and a rotating part. For example, the stationary part may be a diffuser case and the rotating part may be a turbine shaft. Seals may also be used to seal gaps between two stationary parts or two rotating parts of a gas turbine engine. In all cases, minimizing the leakage of the working medium is important in maintaining the efficiency of the system. Thus results in decreased fuel consumption and operation costs. In addition, pressurized air which escapes from the main flowpath has an elevated temperature and may come in contact with engine components whose tolerance for such temperatures is limited.

A common type of labyrinth seal is a knife edge seal. A knife edge seal is generally a ring of material extending radially from a non-rotating component toward a seal land on a neighboring, coannular rotating component (or from the rotating component toward the non-rotating component). The knife edge ring terminates in close proximity to the seal land to inhibit the leakage of air through the gap. During engine operation, the knife edge ring can contact the rotating seal land due to the imbalance of the rotating component, differential thermal response of the components, or imperfections in the concentricity or dimensions of the components. While effective, the contact between the knife edge and the seal land erodes the knife edge ring and the seal land and over time, and may diminish the effectiveness of the seal. The seal effectiveness may be restored by removing the engine from service, replacing or renovating the knife edge ring, and renovating the seal land. Unfortunately, this is a time consuming and expensive process, resulting in loss of revenue while the engine is being serviced. Furthermore, the renovated seal is no more durable than the original seal. The knife edge ring will therefore continue to need to be replaced or renovated periodically throughout the life of the engine.

A brush seal generally includes packs of wire bristles that are sandwiched between two plates. It is common practice to weld the bristles and plates together to bond the components together. The brush seal must then undergo heat treatment after welding to relieve any residual stresses. Heat treatment typically involves securing the brush seal within a fixture and placing the fixture in an oven. The heat treatment is a time consuming and expensive process. Similar to the knife edge ring, the bristles of the brush seal eventually wear and need to be replaced over time. Replacement may be scheduled after a given number of hours or cycles of operation. However, because conventional brush seals are welded assemblies, removal of the brush seal can be difficult. In addition, because the individual components of the brush seal are welded together, individual components such as wire bristles cannot easily be replaced. Thus, replacement of the entire brush seal occur at significant costs with regards to material labor and down time, even though only one of the subassemblies needs replacement.

A current method of maximizing leakage prevention involves combining a brush seal assembly and a labyrinth seal assembly. Examples of such systems include U.S. Pat. Nos. 5,630,590 and 5,704,760 assigned to United Technologies Corporation, both of which are hereby incorporated within. It would be beneficial to develop a brush seal assembly that can be efficiently and inexpensively positioned within a labyrinth seal assembly.

### BRIEF SUMMARY OF THE INVENTION

A seal assembly includes a component of a gas turbine engine having a circumferential surface, a first knife edge seal, a second knife edge seal, and a brush seal assembly. The first knife edge seal and the second knife edge seal extend radially from the circumferential surface of the component and form a gap at the circumferential surface of the component between the first knife edge seal and the second knife edge seal. The brush seal assembly is positioned within the gap between the first knife edge seal and the second knife edge seal and is attached to the circumferential surface of the component.

### BRIEF DESCRIPTION OF THE DRAWINGS

FIG. 1 is a perspective, partial cross-sectional view of a seal assembly.

FIG. 2 is an enlarged, cross-sectional view of the seal assembly.

FIG. 3 is a diagram of a method of assembling the seal assembly.

### DETAILED DESCRIPTION

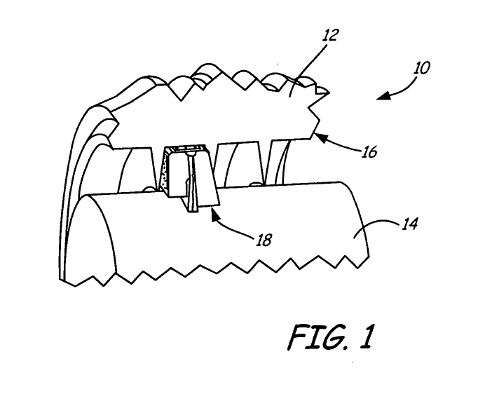

FIG. 1 shows a perspective, partial cross-sectional view of seal assembly 10. Seal assembly 10 generally includes component 12, seal land 14, labyrinth seal assembly 16, and brush seal assembly 18. The ability to easily insert a brush seal assembly 18 within a labyrinth seal assembly 16 of an existing rotating component 12 can greatly enhance the performance of the seal. Potential benefits include little or no machining to existing component 12, seal land 14, and labyrinth seal assembly 16; minimizing overhaul and upgrade time; and performing the bulk of modifications to brush seal assembly 18 at the manufacturing site. Thus, the performance of seal assembly 10 is increased with minimal cost or impact to outage schedules. Seal assembly 10 may be used in any application where a seal is desired, including, but not limited to, a gas turbine engine.

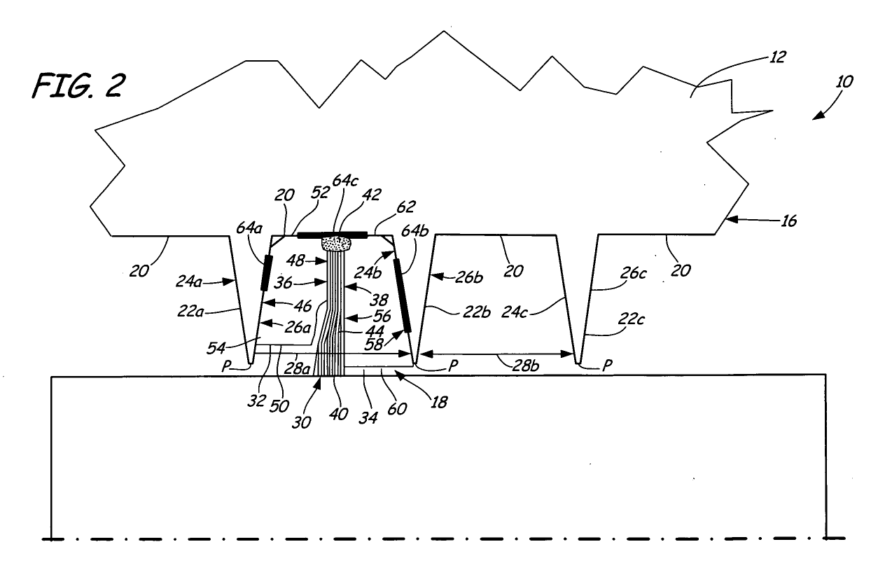

FIG. 2 shows an enlarged, cross-sectional view of seal assembly 10. Component 12 is ring shaped and has an inner diameter forming circumferential surface 20. Labyrinth seal assembly 16 extends from circumferential surface 20 of component 12 and brush seal assembly 18 is attached to circumferential surface 20 of component. Seal land 14 is positioned opposite circumferential surface 20 of component 12 and is engageable with brush seal assembly 18. In operation, component 12 is rotating and works in conjunction with seal land 14, which is stationary, to restrict the escape of a working medium (i.e. air) from the main flowpath through a gap between rotating component 12 and stationary seal land 14. Although component 12 is discussed as being a rotating component and seal land 14 is discussed as being a stationary component of seal assembly 10, component 12 may also be a stationary component and seal land 14 may be a rotating component of seal assembly 10 without departing from the intended scope of the present invention.

Labyrinth seal assembly 16 includes first tooth 22a, second tooth 22b, and third tooth 22c (collectively referred to as teeth 22). First tooth 22a has a first side 24a and a second side 26a, second tooth 22b has a first side 24b and a second side 26b, and third tooth 22c has a first side 24c and a second side 26c (collectively referred to as first side 24 and second side 26). First and second sides 24 and 26 of teeth 22 extend radially from circumferential surface 20 of component 12 toward seal land 14 and are angled such that first and second sides 24 and 26 of each tooth 22a-22c eventually meet at point P. Teeth 22 are spaced from one another along circumferential surface 20 such that a first gap 28a is formed between first tooth 22a and second tooth 22b and a second gap 28b is formed between second tooth 22b and third tooth 22c. First gap 28a is thus defined by second side 26a of first tooth 22a, first side 24b of second tooth 22b, and circumferential surface 20. Likewise, second gap 28b is defined by second side 26b of second tooth 22b, first side 24c of third tooth 22c, and circumferential surface 20. In an exemplary embodiment, teeth 22 are knife edge seals. Although FIGS. 1 and 2 depict labyrinth seal assembly 16 as having three teeth 22a-22c, labyrinth seal system 16 may have any number of teeth 22 without departing from the intended scope of the present invention.

Brush seal assembly 18 is custom manufactured to fit between labyrinth teeth 22. Brush seal assembly 18 is positioned between first tooth 22a and second tooth 22b of labyrinth seal assembly 16 and generally includes bristle assembly 30, side plate 32 and back plate 34. Because brush seal assembly 18 must fit in first gap 28a between first tooth 22a and second tooth 22b of labyrinth seal assembly 16, the overall width, axial face angles, radii, and chamfers of brush seal assembly 18 must be machined to match the profile between first tooth 22a and second tooth 22b. In addition, because brush seal assembly 18 is designed to complement an already existing component 12 and labyrinth seal assembly 16 without altering component 12 or labyrinth seal system 16, brush seal assembly 18 is manufactured in segments to fit the existing hardware.

Bristle assembly 30 is positioned between side plate 32 and back plate 34 and has first side 36, second side 38, inner diameter 40, and outer diameter 42. Bristle assembly 30 is formed of a plurality of densely arranged wire bristles 44 extending from inner diameter 40 to outer diameter 42 of bristle assembly 30. Wire bristles 44 are made of a strong, flexible material. In an exemplary embodiment, wire bristles 44 may be made of an approximately 0.002 inch diameter to an approximately 0.006 inch diameter cobalt alloy wire. In another exemplary embodiment, brush seal assembly 18 may be up to approximately 50 inches in diameter. Prior to sandwiching bristle assembly 30 between side plate 32 and back plate 34, wire bristles 44 may optionally be welded together to form a bristle hoop, simplifying assembly of brush seal assembly 18.

Side plate 32 provides a front cover for brush seal assembly 18 to protect bristle assembly 30 and includes first surface 46, second surface 48, inner diameter 50, and outer diameter 52. When assembled, first side 36 of bristle assembly 30 is positioned immediately adjacent second surface 48 of side plate 32. Optionally, a windage cover 54 may also be integral to side plate 32.

Back plate 34 is the primary structural element of brush seal assembly 18 and provides downstream support to brush seal assembly 18 by supporting bristle assembly 30 and preventing bristle blowover due to fluid pressure differential. Back plate 34 generally includes first surface 56, second surface 58, inner diameter 60, and outer diameter 62. When assembled, second side 38 of bristle assembly 30 is positioned immediately adjacent first surface 56 of back plate 34.

Brush seal assembly 18 is assembled by first aligning outer diameter 62 of back plate 34, outer diameter 52 of side plate 32, and outer diameter 48 of bristle assembly 30. As previously mentioned, bristle assembly 30 is positioned between side plate 32 and back plate 34. After proper alignment, bristle assembly 30, side plate 32, and back plate 34 may be connected to each other to form a uniform part by any means known in the art. In an exemplary embodiment, bristle assembly 30, side plate 32, and back plate 34 are welded together at outer diameters 48, 52, and 62 of bristle assembly 30, side plate 32, and back plate 24, respectively.

To attach brush seal assembly 18 to labyrinth seal assembly 16 and component 12, brush seal assembly 18 is positioned within first gap 28a created by first tooth 22a, second tooth 22b, and circumferential surface 20 of component 12. Brush seal assembly 18 is positioned within first gap 28a such that first surface 46 of side plate 32 abuts second side 26a of first tooth 22a and second surface 58 of back plate 34 abuts first side 24b of second tooth 22b. In addition, outer diameters 48, 52, and 62 of bristle assembly 30, side plate 32, and back plate 34, respectively, abut circumferential surface 20 of component 12 between first tooth 22a and second tooth 22b. In this position, inner diameter 40 of bristle assembly 30 extends past inner diameters 50 and 60 of side plate 32 and back plate 34, allowing bristle assembly 30 to come into contact with seal land 14 and form a seal. Although FIGS. 1 and 2 depict only one brush seal assembly 18 positioned within seal assembly 10, seal assembly 10 may include any number of brush seal assemblies 18 positioned between teeth 22 of labyrinth seal 16 without departing from the intended scope of the present invention. However, only one brush seal 18 will typically be positioned within a given gap 28. For example, a first brush seal assembly 18 may be positioned within first gap 28a between first tooth 22a and second tooth 22b and a second brush seal assembly 18 may be positioned within second gap 28b between second tooth 22b and third tooth 22c.

In an exemplary embodiment, brush seal assembly 18 is brazed to labyrinth seal assembly 16 and component 12 using a first piece of metallic foil 64a, a second piece of metallic foil 64b, and a third piece of metallic foil 64c. First metallic foil 64a is placed on second side 26a of first tooth 22a, second metallic foil 64b is placed on first side 24b second tooth 22b, and third metallic foil 64c is placed on circumferential surface 20 at gap 28a. After metallic foils 64a-64c are in place, brush seal assembly 18 is positioned within first gap 28a such that first surface 46 of side plate 32 contacts first metallic foil 64a on first tooth 22a, second surface 58 of back plate 34 contacts second metallic foil 64b on second tooth 22b, and outer diameters 48, 52, and 62 of bristle assembly 30, side plate 32, and back plate 34, respectively, contact third metallic foil 64c on circumferential surface 20 of component 12. Metallic foils 64a-64c may be formed of materials including, but not limited to: gold and silver. After brush seal assembly 18 is properly positioned within first gap 28a, seal assembly 10 is heated to a temperature above the operating temperature of seal assembly 10 to melt metallic foils 64a-64c, bonding seal assembly 10 together. Although brush seal assembly 18 is discussed as being brazed to labyrinth seal assembly 16 and component 12, brush seal assembly 18 may be attached to labyrinth seal assembly 16 and component 12 by any means known in the art, including, but not limited to: welding (such as electron beam welding), adhesives, or mechanical fasteners.

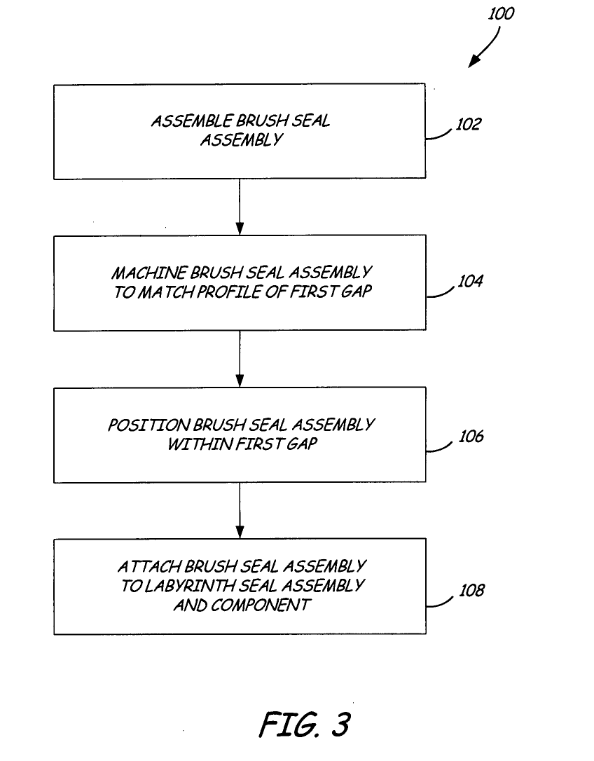

FIG. 3 shows a diagram of a method 100 of assembling seal assembly 10. Brush seal assembly 18 is first assembled by positioning bristle assembly 30 between side plate 32 and back plate 34, Box 102. In an exemplary embodiment, bristle assembly 30, side plate 32, and back plate 34 are welded together. As depicted in Box 104, brush seal assembly 18 is then machined to match the profile of first gap 28a between first tooth 22a and second tooth 22b of labyrinth seal assembly 16. After machining, brush seal assembly 18 is positioned within first gap 28a by sliding brush seal assembly 18 between first tooth 22a and second tooth 22b such that first surface 46 of side plate 32 engages second side 26a of first tooth 22a and second surface 58 of back plate 34 engages first side 24b of second tooth 22b, Box 106. Brush seal assembly 18 is positioned within first gap 28a such that outer diameters 48, 52, and 62 of bristle assembly 30, side plate 32, and back plate 34, respectively, abut circumferential surface 20 of component 12. After brush seal assembly 18 is positioned between first tooth 22a, second tooth 22b, and component 12, brush seal assembly 18 is attached to labyrinth seal assembly 16 and component 12, Box 108. In an exemplary embodiment, brush seal assembly 18 may be attached to labyrinth seal assembly 16 and component 12 by any means known in the art, including, but not limited to: welding, brazing, adhesives, or mechanical fasteners. Although method 100 discusses positioning brush seal assembly 18 within gap 28a and then attaching brush seal assembly 18 to labyrinth seal assembly 16 and component 12, the order may vary depending on the method of attachment used. For example, if brush seal assembly 18 is brazed to labyrinth seal assembly 16 and component 12, metallic foil pieces 64a-64c must be placed on first tooth 22a, second tooth 22b, and component 12 prior to positioning brush seal assembly 18 within first gap 28a. In addition, if desired, a second brush seal assembly may optionally be positioned in second gap 28b between second tooth 22b and third tooth 22c using the same method described above.

The seal assembly of the present invention provides a quick, convenient, and inexpensive method of installing a brush seal assembly between labyrinth teeth of a labyrinth seal assembly of an existing component. By providing a quick method of installing the brush seal component to the existing component, the manufacturing time and cost of the brush seal assembly is significantly reduced. This is accomplished because little or no machining to the existing component, seal land, or labyrinth seal assembly is required and the bulk of modifications to the brush seal assembly may be performed at the manufacturing site. Because the brush seal assembly may be positioned within the labyrinth seal assembly in a short amount of time, such as during a short equipment outage schedule, any disruption to the operation of the seal assembly is minimized. In addition, the simple installation and removal of the brush seal assembly from within the labyrinth teeth also allows for easy replacement of individual components.

Although the present invention has been described with reference to preferred embodiments, workers skilled in the art will recognize that changes may be made in form and detail without departing from the spirit and scope of the invention.

1. A seal assembly comprising:
a component of a gas turbine engine, wherein the component has a circumferential surface;
a first knife edge seal extending radially from the circumferential surface of the component;
a second knife edge seal extending radially from the circumferential surface of the component, wherein the first knife edge seal and the second knife edge seal form a gap at the circumferential surface of the component between the first knife edge seal and the second knife edge seal; and
a first brush seal assembly positioned within the gap between the first knife edge seal and the second knife edge seal, wherein the first brush seal assembly is attached to the circumferential surface of the component.

2. The seal assembly of claim 1, wherein the first brush seal assembly comprises:
a side plate;
a back plate; and
a bristle assembly positioned between the side plate and the back plate.

3. The seal assembly of claim 2, and further comprising a seal land positioned opposite the component, wherein the bristle assembly is engageable with the seal land.

4. The seal assembly of claim 2, wherein the side plate, back plate, and bristle assembly are welded together.

5. The seal assembly of claim 1, and further comprising a third knife edge seal.

6. The seal assembly of claim 5, and further comprising a second brush seal assembly.

7. The seal assembly of claim 1, wherein the first brush seal assembly is attached to the circumferential surface of the component by at least one of: welding, brazing, adhesives, and mechanical fasteners.

8. A seal assembly of a turbine engine having a component, wherein the component has a circumferential surface, the seal assembly comprising:
a first brush seal having a first side and a second side, wherein the brush seal is attached to the circumferential surface of the component;
a first knife edge seal extending from the circumferential surface of the component, wherein the first knife edge seal is in contact with the first side of the first brush seal; and
a second knife edge seal extending from the circumferential surface of the component, wherein the second knife edge seal is in contact with the second side of the first brush seal.

9. The seal assembly of claim 8, wherein the first brush seal comprises:
a side plate;
a back plate; and
a bristle assembly positioned between the side plate and the back plate.

10. The seal assembly of claim 9, wherein the bristle assembly extends beyond the first knife edge seal and the second knife edge seal.

11. The seal assembly of claim 8, and further comprising a third knife edge seal extending from the circumferential surface of the component, wherein the third knife edge seal is positioned proximate the second knife edge seal.

12. The seal assembly of claim 11, and further comprising a second brush seal positioned between the second knife edge seal and the third knife edge seal.

13. The seal assembly of claim 8, wherein the first brush seal is attached to the circumferential surface of the component by at least one of: welding, brazing, adhesives, and mechanical fasteners.

14. The seal assembly of claim 8, wherein the brush seal contacts a seal land positioned proximate the component.

15. A method for assembling a brush seal assembly within a labyrinth seal assembly, the method comprising:
positioning the brush seal assembly between a first knife edge seal and a second knife edge seal of the labyrinth seal assembly; and
attaching the brush seal assembly to the labyrinth seal assembly;
wherein the first knife edge seal, the second knife edge seal, and the brush seal assembly extend from a circumferential surface of the labyrinth seal.

16. The method of claim 15, wherein attaching the brush seal assembly to the labyrinth seal assembly comprises at least one of: welding, brazing, adhesives, and mechanical fasteners.

17. The method of claim 15, wherein positioning the brush seal assembly between a first knife edge seal and a second knife edge seal comprises contacting the brush seal assembly to the first knife edge seal and the second knife edge seal.

18. The method of claim 15, and further comprising assembling the brush seal assembly.

19. The method of claim 18, wherein assembling the brush seal assembly comprises attaching a plurality of bristles between a side plate and a back plate.

20. The method of claim 19, wherein attaching the plurality of bristles between the side plate and the back plate comprises welding the plurality of bristles, the side plate, and the back plate together.
